(19) United States
(12) Patent Application Publication
(10) Pub. No.: US 2012/0080887 A1
(43) Pub. Date: Apr. 5, 2012

(54) SYSTEM AND METHOD FOR STORING ENERGY AND/OR GENERATING EFFICIENT ENERGY

(76) Inventor: Mike Tkadlec, Oakdale, MN (US)

(21) Appl. No.: 13/106,377

(22) Filed: May 12, 2011

Related U.S. Application Data
(60) Provisional application No. 61/333,879, filed on May 12, 2010.

(51) Int. Cl. H02K 7/18; F03D 9/00

(52) U.S. Cl. 290/1 A; 290/55

(57) ABSTRACT

The present disclosure relates to systems and methods for storing energy, such as wind energy, and/or generating generally efficient energy from hydrogen peroxide (H₂O₂). A method for creating electricity may include receiving hydrogen peroxide and decomposing the it to produce steam, which may be used to drive a steam engine. The method may include generating electricity from a wind turbine for use in the production of the hydrogen peroxide. The steam engine may be coupled to a magnetic drive assembly, which may include a first drive magnet having magnetic shielding on a portion thereof, a first motion magnet, and a first acceleration field created by the interaction between the first drive magnet and first motion magnet as the first motion magnet is passed through an altered magnetic field of the first drive magnet. The output of the magnetic drive assembly may be used to drive a generator for creating electricity.

### CROSS-REFERENCE TO RELATED APPLICATIONS

This application claims priority to U.S. Patent Application Ser. No. 61/333,879, filed on May 12, 2010, the entire contents of which are incorporated herein by reference.

### FIELD OF THE INVENTION

The present disclosure relates to systems and methods for storing energy and/or generating generally efficient energy from hydrogen peroxide (H₂O₂). More particularly, the present disclosure relates to storing energy that is produced at one point in time in a form for later use. Even more particularly, the present disclosure relates to systems and methods for storing wind energy.

### BACKGROUND OF THE INVENTION

Wind energy and other alternative energy sources are an excellent solution to the world's energy needs. However, the shortcoming of many types of alternative energy sources is the ability to produce constant energy when demand is high. Certain energies, such as wind energy, can only be produced sporadically, for example. When the wind blows, large amounts of energy can be put down line; but when the wind weakens or stops blowing, so does energy flow. Additionally, due to a lack of sufficient energy storage techniques, energy produced by wind turbines and the like is often wasted when there is not an immediate demand for power.

Thus, there exists a need in the art for systems and methods for storing energy and/or generating generally efficient energy from hydrogen peroxide (H₂O₂). Additionally, there exists a need in the art for systems and methods for storing energy that is produced at one point in time in a form for later use. Even further, there exists a need in the art for systems and methods for storing wind energy, such that when the wind blows and the demand for energy is down, the energy can be stored until the demand for the energy is higher.

### BRIEF SUMMARY OF THE INVENTION

The present disclosure relates to an energy storage system and method for efficiently storing energy. The stored energy can be used on-demand to produce electricity. The present disclosure particularly relates to methods and systems for storing and consuming wind energy. The system and method generally have a very low ecological impact, utilizing all renewable sources.

The present disclosure, in one embodiment, relates to a method for creating electricity. The method may include receiving hydrogen peroxide from a containment vessel and decomposing the hydrogen peroxide to produce steam. The steam may be used to drive a steam engine. The steam engine may be operably coupled to a magnetic drive assembly, which may include a first drive magnet having magnetic shielding on a portion thereof altering the magnetic field of the first drive magnet, a first motion magnet, and a first acceleration field created by the interaction between the first drive magnet and the first motion magnet as the first motion magnet is passed through the altered magnetic field of the first drive magnet. The output of the magnetic drive assembly may be used to drive a generator for creating electricity.

The present disclosure, in another embodiment, relates to a system for storing and creating energy. The system may include a containment vessel for storing hydrogen peroxide and a decomposition chamber configured to decompose the hydrogen peroxide to produce steam. A steam engine may be driven by the steam produced by the decomposition chamber and may further be operably coupled to a magnetic drive assembly, which may include a first drive magnet having magnetic shielding on a portion thereof altering the magnetic field of the first drive magnet, a first motion magnet, and a first acceleration field created by the interaction between the first drive magnet and the first motion magnet as the first motion magnet is passed through the altered magnetic field of the first drive magnet. A generator may be provided for creating electricity using the output of the magnetic drive assembly.

The present disclosure, in yet another embodiment, relates to a method for storing wind energy for later use. The method may include generating electricity from a wind turbine for use in the production of hydrogen peroxide, storing the hydrogen peroxide in a containment vessel, and decomposing the hydrogen peroxide to produce steam. The steam may be used to drive a steam engine.

The present disclosure, in still another embodiment, relates to a system for storing wind energy for later use. The system may include a collection system for receiving electricity produced by a wind turbine and collecting hydrogen and oxygen via electrolysis of water, a hydrogen peroxide producing system for receiving the collected hydrogen and oxygen and producing hydrogen peroxide, a storage vessel for storing the hydrogen peroxide for later use, and a decomposition system for decomposing the hydrogen peroxide to produce steam. A steam engine may be driven by the produced steam.

While multiple embodiments are disclosed, still other embodiments of the present disclosure will become apparent to those skilled in the art from the following detailed description, which shows and describes illustrative embodiments of the disclosure. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the embodiments will be better understood from the following description taken in conjunction with the accompanying Figures, in which:

FIG. 1 illustrates a method for storing energy according to an embodiment of the present disclosure.

FIG. 2 shows an autoxidation process for producing H₂O₂ according to an embodiment of the present disclosure.

FIG. 3 illustrates an H₂O₂ containment vessel according to an embodiment of the present disclosure.

FIG. 4 illustrates a decomposition system according to an embodiment of the present disclosure.

FIG. 5 illustrates a system used to convert H₂O₂ to AC power according to an embodiment of the present disclosure.

### DETAILED DESCRIPTION

The present disclosure relates to novel and advantageous systems and methods for storing energy and/or generating generally efficient energy from hydrogen peroxide (H₂O₂). More particularly, the present disclosure relates to storing energy that is produced at one point in time in a form for later use. Even more particularly, the present disclosure relates to systems and methods for storing wind energy.

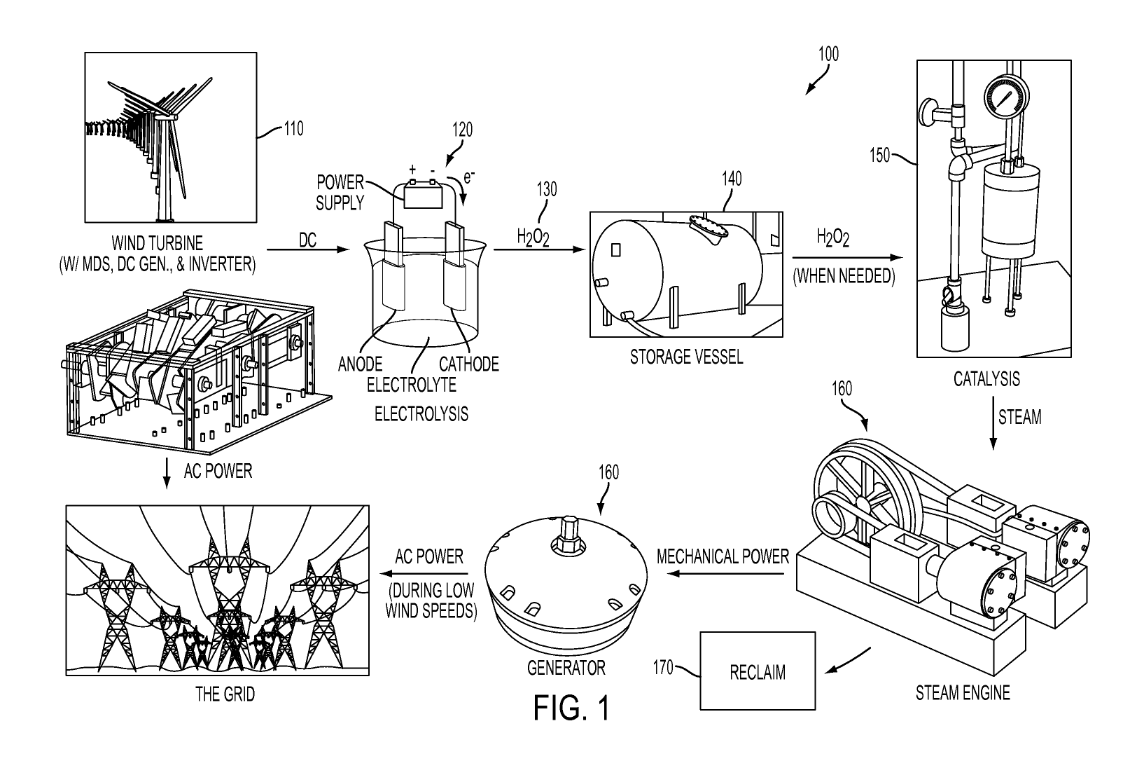

FIG. 1 illustrates a method for storing energy according to an embodiment of the present disclosure. While the energy storing methods and systems below are described with respect to energy generated by wind turbines, such energy production may be replaced with any energy production method, such as solar energy, hydroelectric energy, geothermal energy, or other energy producing methods.

Generally, power grids have time periods of high demand and low demand for energy consumption. During times of high demand for energy, intermittent energy production methods, such as wind turbines and solar energy may produce AC power directly to the power grid for immediate consumption. However, when energy demand on the power grid drops, the excess energy produced by some intermittent energy producers may not be needed and may thus be wasted. Accordingly, in certain embodiments of the present disclosure, storing energy during time periods of low energy demand may avoid such waste and inefficiency. According to the present disclosure, however, energy may be stored during both high or low demand energy time periods depending on need, in order to maximize efficiency.

As can be seen in FIG. 1, generally, a method to store energy may utilize a wind turbine or other energy source to run a generator and create AC power for output directly to a power grid. However, when there is a need to store the energy produced, for example, by the wind turbines, the energy may be used to drive an electrolysis process to decompose water to produce hydrogen gas (H₂) and oxygen gas (O₂). The separated hydrogen and oxygen gas may then be autoxidized to produce hydrogen peroxide (H₂O₂). The H₂O₂ may be easily stored, such as during times of low energy demand. When more energy is needed, the H₂O₂ may be decomposed to produce heat, steam, and oxygen. The steam may be used to run a steam engine to create mechanical power, which in turn may be used to run a generator. The generator can create AC power, which may be output to a power grid or used locally. The steam and oxygen that is produced may then be reclaimed for re-use in the electrolysis process. The cycle may then be repeated. In this regard, energy may be stored for use at a later time.

As further shown in FIG. 1, generally, a system according to the present disclosure may include one of a variety of power-producing devices, including intermittent energy producing devices, such as but not limited to, a wind turbine. Other energy sources may include a hydroelectric turbine, a solar powered generator, or other similar devices or combination of devices. The system may further include an electrolysis device for receiving the electricity produced by the power generator and decomposing water into hydrogen and oxygen gas. The system may include an autoxidation device to recombine the hydrogen and oxygen into H₂O₂, which may be stored in an H₂O₂ reservoir or other containment system or vessel. When needed or otherwise desired, the H₂O₂ may be withdrawn from the reservoir, and a thermo-catalytic device may decompose the H₂O₂ into gaseous water (steam) and oxygen. A steam engine can use the steam from the thermo-catalytic device for driving power and may be coupled to and drive a generator to produce AC power for output to a power grid or for use locally. As described further below, one or more magnetic drive systems may be used with the steam engine to enhance the system.

Having generally discussed the system and method, one embodiment of method 100 will now be described. In step 110, wind turbines may be used to produce electricity in generally the normal manner. Wind turbines 100 may utilize a variety of drive systems. In some embodiments, such drive systems may include the magnetic drive systems described in U.S. Pat. No. 7,385,325, titled “Magnetic Propulsion Motor,” issued Jun. 10, 2008, U.S. Pat. No. 7,777,377, titled “Magnetic Propulsion Motor,” filed Jun. 9, 2008, and U.S. application Ser. No. 12/548,233, titled “Magnetic Propulsion Motor,” filed Aug. 26, 2009, each of which is hereby incorporated by reference herein in its entirety. As previously mentioned, electricity may be generated by a variety of means in order to produce the requisite energy in step 110 and is not limited to energy from wind turbines. This electricity produced by the turbine, which may be in the form of a direct current (DC), may be transmitted to the electrolysis device and used in combination with an electrolysis process.

In a step 120, the electrolysis device may decompose water contained within the electrolysis device into gaseous hydrogen and oxygen. The electrical power source, such as the turbine in step 110, may be operably connected to two electrodes, including an anode and a cathode. The negatively charged cathode and the positively charged anode may be composed of an inert metal, such as platinum, stainless steel, or similar metal. The electrical current from step 110 may be applied to both the anode and cathode, which may be then be placed, or may already be positioned, in the water. In some embodiments, a membrane may be used to separate the anode from the cathode. This separation may facilitate the electrolysis by reducing unwanted side reactions, thereby maximizing efficiency of the electrolysis reaction. In water electrolysis, oxygen gas collects at the anode, while hydrogen collects at the cathode. The oxygen and hydrogen may then be collected at the anode and cathode, respectively, and may be stored in collection cylinders, or similar collection devices. Assuming ideal efficiency, following the electrolysis reaction, the amount of hydrogen gas collected may be approximately twice the amount of oxygen gas collected.

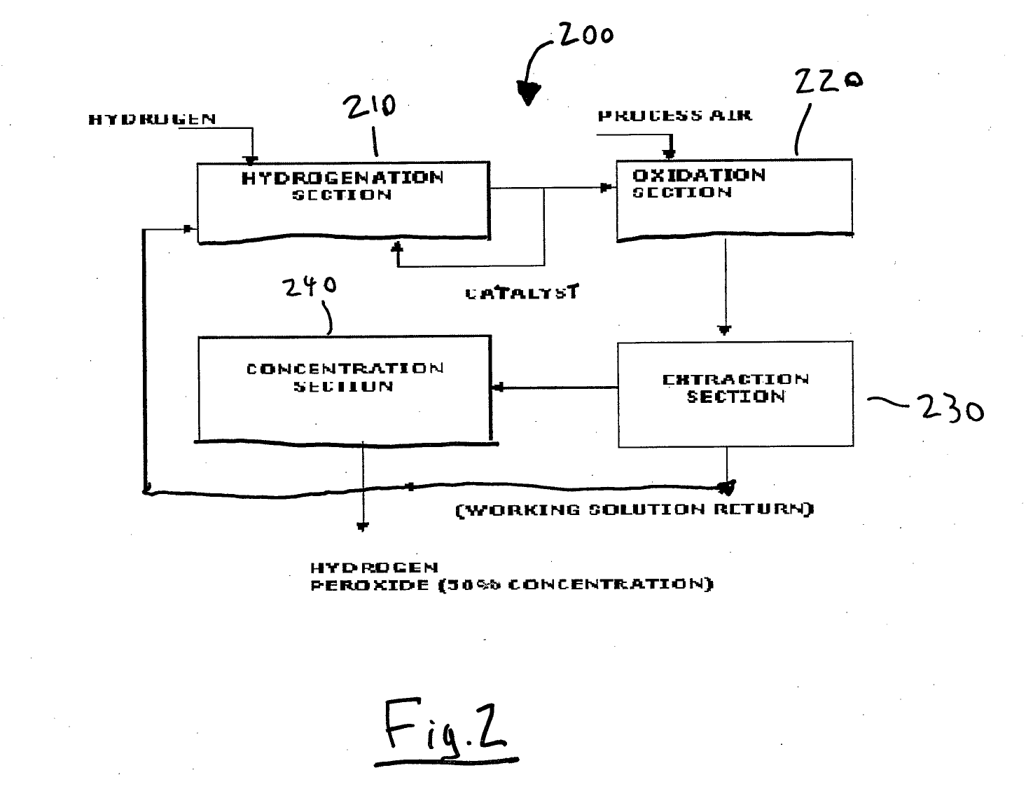

In step 130, the hydrogen and oxygen produced in step 120 may be converted into H₂O₂ using autoxidation. The autoxidation of H₂O₂ may be performed by an autoxidation device. In some embodiments, for example, a H₂O₂ plant or system may perform the autoxidation to produce the H₂O₂. In certain embodiments, the autoxidation device may be on-site, or relatively near the wind turbines. Although, it is not necessary that the autoxidation device be near the wind turbines, and instead the device could be remotely located. FIG. 2 illustrates an example of an autoxidation process for producing H₂O₂; however, other suitable processes may be used. The illustrated process 200, typically known as the Reidl-Pfleiderer process, includes combining the hydrogen gas produced with a hydrogenation catalyst at step 210. The hydrogen gas and catalyst are then united with oxygen at step 220. In some embodiments, the oxygen used in step 220 may be from ambient air. In step 230, the recombined H₂O₂ is extracted, and is then concentrated to the desired concentration levels in step 240. In one embodiment, the H₂O₂ produced may be in concentrations of 50 to 90%.

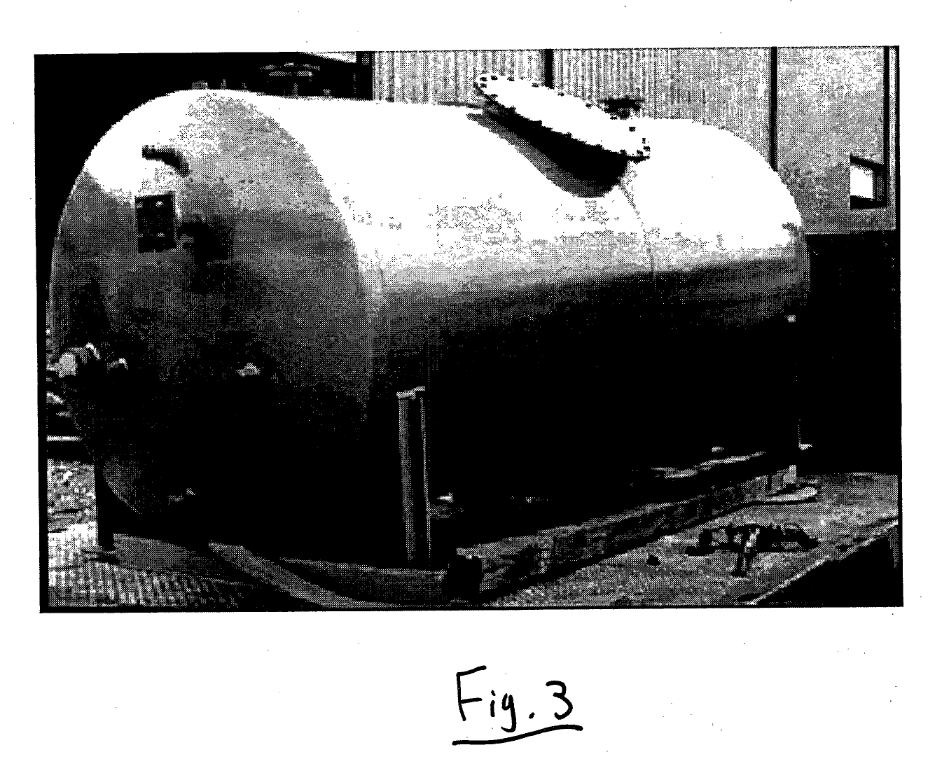

In step 140 of FIG. 1, the H₂O₂ produced as shown in the process illustrated in FIG. 2 may then be stored, remotely or on-site, in a reservoir or other containment system or vessel for later use. FIG. 3 illustrates an example of a containment vessel for the H₂O₂ produced in step 130. According to some embodiments of the present invention, the H₂O₂ reservoir may include underground containment vessels for storage at stable conditions and temperature. In one embodiment, H₂O₂ may be stored at 65 degrees Fahrenheit with 1% weight loss per year or less.

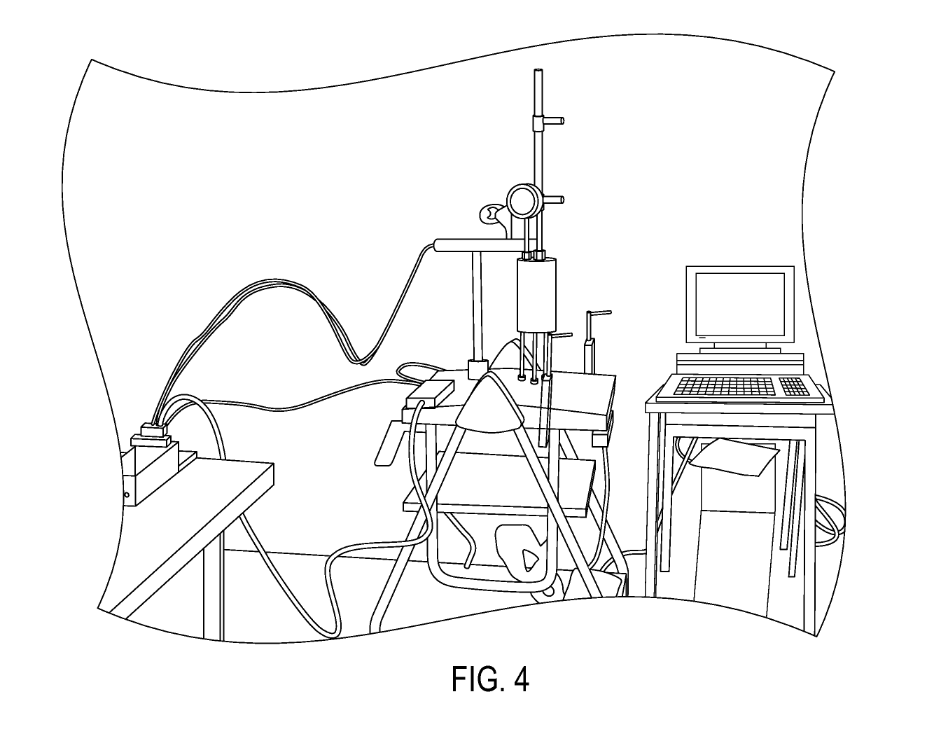

In step 150 of one embodiment, the H₂O₂ may be withdrawn from the reservoir and provided to a thermo-catalytic device for decomposition. This may be done, for example, when the demand for energy has increased, or otherwise when more energy is desirable. In one embodiment the H₂O₂ may be introduced to a catalyst, and the resulting decomposition reaction will produce heat, water (in the form of steam), and oxygen gas. In another embodiment, the H₂O₂ may be heated by the thermo-catalytic device until decomposition of the H₂O₂ takes place. After reaching a certain threshold within the thermo-catalytic device, the resulting steam, oxygen, and heat function as the catalyst for the decomposition reaction, thus rendering the reaction substantially or entirely autocatalytic and sustainable. An example decomposition system is illustrated in FIG. 4.

In step 160, the gaseous expansion of steam resulting from the H₂O₂ decomposition reaction may be captured and utilized in a steam engine, in one embodiment. The steam engine can be selected because of its unique ability to use saturated steam. The steam engine may then convert the steam pressure resulting from the decomposition reaction into mechanical energy by rotating a turbine. The rotating steam-driven turbine may further be coupled to a generator in order to produce electricity for the power grid or for use locally when there is a demand or desire for energy. In some embodiments, the generator may produce AC power. As more H₂O₂ is decomposed and converted to steam energy, more mechanical energy may be transferred from the steam engine to the generator, thus producing more power.

Certain steam engines may however have limited RPMs and other limitations. Therefore, in some embodiments, an additional drive system or drive systems may be integrated with the steam engine to increase RPMs and increase efficiency of the storage system. Such drive systems may include the magnetic drive systems described in U.S. Pat. No. 7,385,325, titled “Magnetic Propulsion Motor,” issued Jun. 10, 2008, U.S. Pat. No. 7,777,377, titled “Magnetic Propulsion Motor,” filed Jun. 9, 2008, and U.S. application Ser. No. 12/548,233, titled “Magnetic Propulsion Motor,” filed Aug. 26, 2009, which were previously incorporated by reference herein.

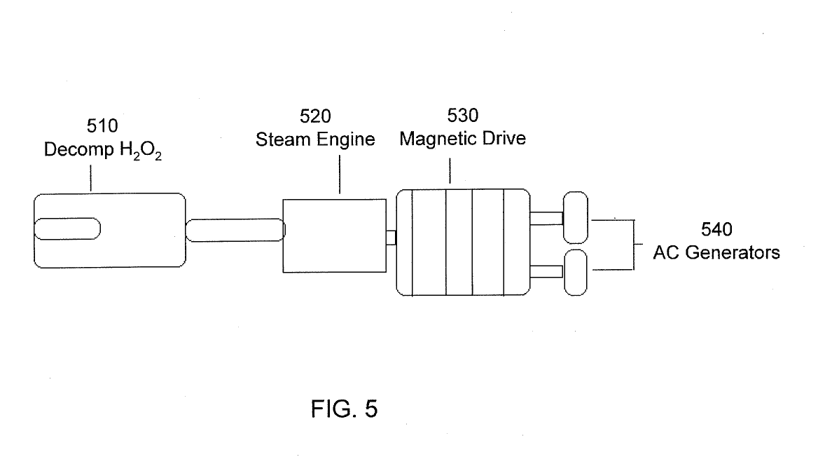

As discussed in the above-incorporated patents and applications, a magnetic drive system in some embodiments, may include one or more drive magnets, a motion magnet, and an acceleration field. The drive magnet may include magnetic shielding, typically on a portion thereof, altering the magnetic field of the drive magnet. In some embodiments, the motion magnet may have a cross-section that is generally in the shape of a ‘V’ or ‘A’. The acceleration field may be created by the interaction between the drive magnet and the motion magnet as the motion magnet is passed through the altered magnetic field of the drive magnet. The altered magnetic field of the drive magnet may often be near the first end of the drive magnet. The motion magnet may be operably coupled to an output shaft and rotate around the central axis of the output shaft. Multiple drive magnets may also be added, thereby adding more acceleration fields created by the interaction between the drive magnets and motion magnets. Output power and/or torque from the steam engine may be increased or enhanced by use of such magnetic drive systems. Running the power from the steam engine, with or without additional drive systems, to AC generators can produce clean AC power (e.g., 60 Hz AC power), which can then be transmitted to a power grid or used locally. An example system according to an embodiment of the present invention is illustrated in FIG. 5. FIG. 5 depicts decomposition chamber 510 operably coupled to steam engine 520. The steam produced by the decomposition chamber 510 drives steam engine 520, which in turn transfers output mechanical power through magnetic drive assembly 530. AC generators 540 then convert the mechanical energy received from magnetic drive assemblies 530 into electrical power.

In step 170, the exhaust from the steam engine, which may consist of water, oxygen, and small particles of the catalyst, may be reclaimed for reuse. For example, the exhaust may be captured, put through a condenser to liquefy, put through a filter to remove the small particles of catalyst, and then recycled into the electrolysis bed for hydrogen and oxygen separation. The oxygen can be siphoned off for use in hydrogen peroxide production, released to the atmosphere, or used as an accelerant to increase the steam production for the steam engine. Additionally, the processes for capturing the exhaust from the steam engine could reduce the amount of water needed for the electrolysis, thereby having a very low impact to the ecology of the region.

Although the various embodiments of the present disclosure have been described with reference to preferred embodiments, persons skilled in the art will recognize that changes may be made in form and detail without departing from the spirit and scope of the present disclosure.

We claim:

1. A method for creating electricity comprising:
receiving hydrogen peroxide from a containment vessel;
decomposing the hydrogen peroxide to produce steam;
using the steam to drive a steam engine, wherein the steam engine is operably coupled to a magnetic drive assembly comprising:
a first drive magnet having magnetic shielding on a portion thereof altering the magnetic field of the first drive magnet;
a first motion magnet; and
a first acceleration field created by the interaction between the first drive magnet and the first motion magnet as the first motion magnet is passed through the altered magnetic field of the first drive magnet; and
using the output of the at least one magnetic drive assembly to drive a generator for creating electricity.

2. The method of claim 1, further comprising using energy output from an intermittent power generator for the production of the hydrogen peroxide.

3. The method of claim 2, wherein the intermittent power generator is a wind turbine.

4. The method of claim 3, wherein the intermittent power generator produces electricity to drive the electrolysis of water.

5. The method of claim 4, wherein the hydrogen peroxide is produced by autoxidation.

6. The method of claim 1, wherein the decomposition of the hydrogen peroxide comprises an autocatalytic process.

7. The method of claim 1, further comprising reclaiming the steam and oxygen generated by the decomposition of the hydrogen peroxide.

8. A system for storing and creating energy, comprising:
a containment vessel for storing hydrogen peroxide;
a decomposition chamber configured to decompose the hydrogen peroxide to produce steam;
a steam engine driven by the steam produced by the decomposition chamber and operably coupled to a magnetic drive assembly comprising:
a first drive magnet having magnetic shielding on a portion thereof altering the magnetic field of the first drive magnet;
a first motion magnet; and
a first acceleration field created by the interaction between the first drive magnet and the first motion magnet as the first motion magnet is passed through the altered magnetic field of the first drive magnet; and
a generator for creating electricity using the output of the at least one magnetic drive assembly.

9. The system of claim 8, further comprising an intermittent power generator providing energy for the production of the hydrogen peroxide.

10. The system of claim 9, wherein the intermittent power generator is a wind turbine.

11. The system of claim 9, wherein the intermittent power generator produces electricity to drive the electrolysis of water.

12. The system of claim 9, wherein the hydrogen peroxide is produced by autoxidation.

13. The system of claim 8, wherein the decomposition of the hydrogen peroxide comprises an autocatalytic process.

14. The system of claim 3, further comprising means for reclaiming the steam and oxygen generated by the decomposition of the hydrogen peroxide.

15. A method for storing wind energy for later use, comprising:
generating electricity from a wind turbine for use in the production of hydrogen peroxide;
storing the hydrogen peroxide in a containment vessel;
decomposing the hydrogen peroxide to produce steam; and
using the steam to drive a steam engine.

16. The method of claim 15, further comprising using the output of the steam engine to drive a generator for creating electricity.

17. The method of claim 15, further comprising producing the hydrogen peroxide by autoxidation.

18. The method of claim 17, wherein hydrogen and oxygen used in the autoxidation are produced by the electrolysis of water powered by the wind turbine.

19. The method of claim 15, wherein decomposing the hydrogen peroxide comprises an autocatalytic process.

20. The method of claim 15, further comprising reclaiming the steam generated by the decomposition of the hydrogen peroxide.

21. A system for storing wind energy for later use, comprising:
a collection system for receiving electricity produced by a wind turbine and collecting hydrogen and oxygen via electrolysis of water;
a hydrogen peroxide producing system for receiving the collected hydrogen and oxygen and producing hydrogen peroxide;
a storage vessel for storing the hydrogen peroxide for later use;
a decomposition system for decomposing the hydrogen peroxide to produce steam; and
using the steam to drive a steam engine.
